(19) United States
(12) Patent Application Publication
(10) Pub. No.: US 2011/0022744 A1
(43) Pub. Date: Jan. 27, 2011

(54) Storage Control Method and Related Storage Control Device for a Computer System

(76) Inventor: Zhi-Ming Sun, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/629,052

(22) Filed: Dec. 2, 2009

(30) Foreign Application Priority Data
Jul. 22, 2009 (TW) 098124716

(51) Int. Cl. G06F 3/00

(52) U.S. Cl. 710/51

(57) ABSTRACT

A storage control method for a computer system for automatically executing off line at a proper time includes a storage controller generating a command for accessing a storage device, receiving and transmitting the command through a port multiplier, and the port multiplier performing off line when a ready packet is not received from the storage device or the storage device is absent.

### BACKGROUND OF THE INVENTION

1. Field of the Invention

The present invention relates to a storage control method and related storage control device for a computer system, and more particularly, to a storage control method and related storage control device for automatically executing off line at a proper time.

2. Description of the Prior Art

A storage device is always an integral part of a computer system, and there are many types of storage devices with different functions, such as floppy disk, hard disk, CD-ROM, flash memory, and so on. As to data transmission between the computer system and the storage device, the computer system usually utilizes a storage controller for converting an order from the computer system to a command for accessing the storage device. That is, data in the storage device needs to be processed via the computer system, and as a result, for utilization convenience, kinds of external interface devices are developed for facilitating the computer system to connect with the storage device. The computer system can simply and quickly access these storage devices through an external connecting method.

In the prior art, the external connecting method utilizes a port multiplier with a plurality of connecting ports for connecting a plurality of storage devices simultaneously to connect the port multiplier with the storage controller. According to this connecting method, the storage device in any one of the plurality of connecting ports can perform data transmission with the computer system through the storage controller.

Based on the abovementioned external connecting method, when the computer system is booted, the storage controller transmits an online signal to the port multiplier, and after the port multiplier responds to the online signal, the storage controller establishes a link with the port multiplier. At this time, the storage controller is preset in a busy state. Please note that, when the storage controller stays in the busy state, just a few commands can be transmitted. After the storage device is ready (generally, the storage device will be ready within 10 seconds), the storage device transmits a ready packet to the storage controller. Then, the storage controller leaves the busy state according to the ready packet, and enters a ready state. That is, after the storage controller is connected to the storage device, the storage controller still needs to wait for the ready packet sent by the storage device when ready to access the storage device normally.

In other words, after the storage controller connects to the storage device, if the storage controller does not receive the ready packet from the storage device, the storage controller waits for a predetermined time (around 30 seconds), and then leaves the busy state. In addition, the storage controller declares the corresponding connecting port failure, and then the computer system continues the successive boot operation. In this situation, if the port multiplier does not connect to any storage device, or the storage device is not ready for transmitting the ready packet to the storage controller, the storage controller stays in the busy state. Therefore, a user needs to wait for a period time for the computer system before continuing the successive boot operation.

### SUMMARY OF THE INVENTION

Therefore, the present invention provides a storage control method and related storage control device for a computer system, for automatically executing off line at a proper time.

The present invention discloses a storage control method for a computer system. The storage control method includes a storage controller generating a command for accessing a storage device, receiving and transmitting the command through a port multiplier, and the port multiplier performing off line when a ready packet is not received from the storage device or the storage device is absent.

The present invention further discloses a storage control device for a computer system. The storage control device includes a storage controller connected to the computer system, for generating a command to a storage device, for accessing the storage device, and a port multiplier connected to the storage controller and the storage device, for receiving the command through a first interface and transmitting the command through a second interface, wherein the port multiplier performs off line when the storage controller does not receive a ready packet from the storage device or the storage device is absent.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a storage control device according to an embodiment of the present invention.

FIG. 2 is a flowchart diagram of a storage control process according to an embodiment of the present invention.

### DETAILED DESCRIPTION

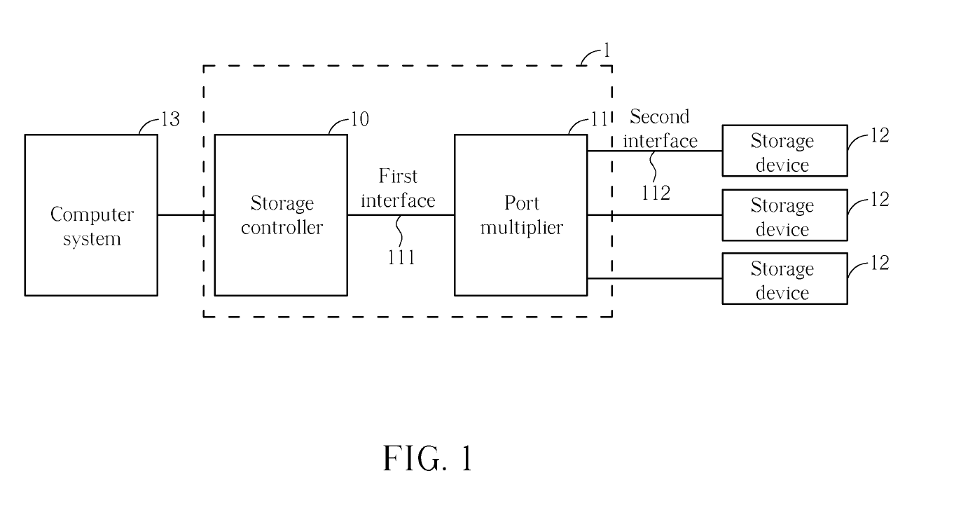

Please refer to FIG. 1, which is a schematic diagram of a storage control device 1 for a computer system 13 according to an embodiment of the present invention. The storage control device 1 can automatically execute off line at a proper time, which includes a storage controller 10 and a port multiplier 11. The storage controller 10 is connected to the computer system 13, and is used for generating a command to a storage device 12, for accessing the storage device 12. The port multiplier 11 connects the storage controller 10 with the storage device 12, and is used for receiving the command transmitted from the storage controller 10 through a first interface 111 and transmitting the command to the storage device 12 through a second interface 112. When the storage controller 10 does not receive a ready packet transmitted from the storage device 12, the port multiplier 11 performs off line.

The storage controller 10 controls data transmission between the storage device 12 and the computer system 13 through the port multiplier 11. If the port multiplier 11 does not receive the ready packet transmitted from the storage device 12 or the storage device 12 is absent, the port multiplier 11 automatically performs off line to disconnect the port multiplier 11 from the storage controller 10.

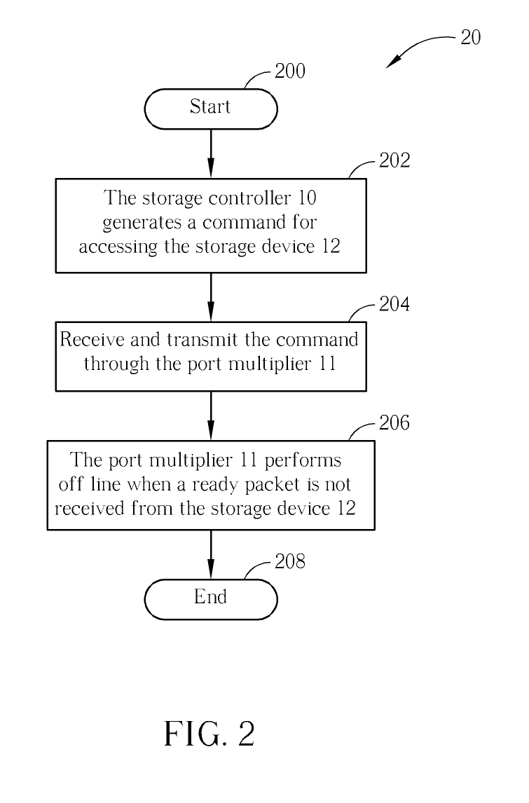

Upon an operation of the storage control device 1, please refer to FIG. 2, which can be included into a storage control process 20 for automatically executing off line at a proper time. In FIG. 2, the storage control process 20 includes the following steps:

Step 200: Start.

Step 202: The storage controller 10 generates a command for accessing the storage device 12.

Step 204: Receive and transmit the command through the port multiplier 11.

Step 206: The port multiplier 11 performs off line when a ready packet is not received from the storage device 12.

Step 208: End.

According to the abovementioned storage control process 20, the port multiplier 11 of the present invention can automatically disconnect with the storage controller 10 when the ready packet is not received from the storage device 12 or the storage device 12 is absent. As a result, the present invention can shorten the waiting time and avoid the computer system 13 staying in the busy state, causing a boot operation of the computer system 13 delay. Detailed description can be referred as following.

First, when the storage control device 1 is initiated, the storage controller 10 transmits the online signal to the port multiplier 11 through the first interface 111. After the online signal is received, the port multiplier 11 responds with a corresponding signal for establishing a link between the storage controller 10 and the port multiplier 11. Similarly, the port multiplier 11 transmits the online signal to the storage device 12 through the second interface 112. If the storage device 12 responds with a corresponding signal and a ready packet, a link between the storage controller 10 and the storage device 12 is established, and then the storage controller 10 can transmit a command for accessing the storage device 12. If the storage device 12 does not respond with the corresponding signal and the ready packet to the storage controller 10, the port multiplier 11 performs off line to disconnect the port multiplier 11 from the storage controller 10.

In the present invention, the storage control device 1 automatically executes off line at a proper time which indicates that the port multiplier 11 automatically performs off line when the storage device 12 is not connected to the port multiplier 11, or is not ready. In the prior art, when the storage controller does not receive the ready packet, the storage controller stays in the bust state, and the computer system waits for a predetermined time for continuing other operations (such as a successive boot operation)). In comparison, in the present invention, when the storage controller 10 does not receive the ready packet, the port multiplier 11 automatically performs off line. That is, the port multiplier 11 does not respond to a signal or command transmitted from the storage controller 10, and the port multiplier 11 seems to be disconnected from the storage controller 10. Preferably, the signal is an online signal, or an out of band (OOB) signal.

Please note that, the storage control device 1 shown in FIG. 1 is only an exemplary embodiment, and those skilled in the art can make alternations and modifications accordingly. For example, the port multiplier 11 is preferably a SATA port multiplier, and the first interface 111 and the second interface 112 respectively correspond to a SATA reception interface and transmission interface. In addition, the storage controller 10 is usually a host bus adaptor, and is preferably a SATA host bus adaptor.

In the prior art, when the computer system is booted, if the storage device is not connected to the port multiplier or the storage device is not ready, the storage controller stays in the busy state, so the computer system cannot execute the successive boot operation. In order to complete the successive boot operation, the storage controller needs to wait for a predetermined time (around 30 seconds) to disconnect the storage controller from the port multiplier, and then leaves the busy state. When the storage control device 1 of the present invention confirms that the storage device 12 is not connected or is not ready (the ready packet is usually transmitted to the storage controller 10 within 10 seconds), the port multiplier 11 performs off line, to make the storage controller 10 leave the busy state to make the computer system continuously execute the successive operation. Therefore, the present invention compared to the prior art can reduce the wait time, and avoid the boot operation of the computer system delay because of the busy state of the storage controller.

In conclusion, in the storage control device of the present invention, the port multiplier can automatically perform off line, so the storage controller does not always stay in the busy state, and the computer system can successfully perform the boot operation or give commands, shortening the wait time for the computer system to complete the boot operation.

Those skilled in the art will readily observe that numerous modifications and alterations of the device and method may be made while retaining the teachings of the invention.

What is claimed is:

1. A storage control method for a computer system for automatically executing off line at a proper time, the storage control method comprising:
a storage controller generating a command for accessing a storage device;
receiving and transmitting the command through a port multiplier; and
the port multiplier performing off line when a ready packet is not received from the storage device or the storage device is absent.

2. The storage control method of claim 1, wherein the port multiplier performing off line comprises the port multiplier does not respond to a signal transmitted from the storage controller.

3. The storage control method of claim 2, wherein the signal is an online signal.

4. The storage control method of claim 3, wherein the online signal is an out of band (OOB) signal.

5. The storage control method of claim 1, wherein the ready packet is used for controlling the storage controller entering a ready state.

6. The storage control method of claim 5, wherein the storage controller entering the ready state comprises the storage controller can transmit an access command to the storage device.

7. The storage control method of claim 1, wherein the port multiplier receives the command through a Serial Advanced Technology Attachment (SATA) interface.

8. The storage control method of claim 1, wherein the storage controller is a SATA host bus adaptor.

9. The storage control method of claim 1, wherein the port multiplier is a SATA port multiplier.

10. The storage control method of claim 1, wherein the storage device is a SATA hard disk.

11. A storage control device for a computer system for automatically executing off line at a proper time comprising:
a storage controller connected to the computer system, for generating a command to a storage device, for accessing the storage device; and
a port multiplier connected to the storage controller and the storage device, for receiving the command through a first interface and transmitting the command through a second interface;
wherein the port multiplier performs off line when the storage controller does not receive a ready packet from the storage device or the storage device is absent.

12. The storage control device of claim 11, wherein the port multiplier performs off line comprises the port multiplier does not respond to a signal transmitted from the storage controller.

13. The storage control device of claim 12, wherein the signal is an online signal.

14. The storage control device of claim 13, wherein the online signal is an out of band (OOB) signal.

15. The storage control device of claim 11, wherein the ready packet is used for controlling the storage controller entering a ready state.

16. The storage control device of claim 15, wherein the storage controller entering the ready state comprises the storage controller can transmit an access command to the storage device.

17. The storage control device of claim 11, wherein the first interface is a Serial Advanced Technology Attachment (SATA) interface.

18. The storage control device of claim 11, wherein the storage controller is a SATA host bus adaptor.

19. The storage control device of claim 11, wherein the port multiplier is a SATA port multiplier.

20. The storage control device of claim 11, wherein the storage device is a SATA hard disk.
